(19) United States
(12) Patent Application Publication
(10) Pub. No.: US 2023/0099736 A1
(43) Pub. Date: Mar. 30, 2023

(54) CONFIRMATION DEVICE, CONFIRMATION SYSTEM, CONFIRMATION METHOD, AND RECORDING MEDIUM

(71) Applicant: NEC Corporation, Minato-ku, Tokyo (JP)

(72) Inventor: Koji TAKETA, Tokyo (JP)

(73) Assignee: NEC Corporation, Minato-ku, Tokyo (JP)

(21) Appl. No.: 17/792,894

(22) PCT Filed: Jan. 31, 2020
(86) PCT No.: PCT/JP2020/003730

§ 371 Date: Jul. 14, 2022

(51) Int. Cl. G09B 7/06; G06F 3/01; G06V 40/16

(52) U.S. Cl. CPC G09B 7/06; G06F 3/013; G06V 40/172

(57) ABSTRACT

To achieve higher speed of deriving information that shows the selection status of options while also saving space and reducing communication cost, this confirmation device is provided with: a target display processing means for presentation of options on an image for target that is viewed by targets for whom an actor who performs confirmation performs confirmation; an acquisition processing means that acquires video information presenting video of the target observing the options; and a first presentation processing means that derives first selection status information that shows the status of the selection of the options by each target on the basis of the line of sight of the target derived from the video information and provides the actor with the first selection status information.

### TECHNICAL FIELD

The present invention relates to confirmation of a status of an object parson.

### BACKGROUND ART

In general, a paper-based test is conducted as a method of confirming a degree of understanding of students for a class content. However, the paper-based test requires time and effort by a teacher and the like for marking. Therefore, the paper-based test is burdensome for the teacher, and it is difficult for the teacher to immediately reflect the confirmed degree of understanding in a class content.

Therefore, when it is desired to simply confirm the degree of understanding of students for the class content, the teacher generally uses a method in which the teacher poses a question to the students, asks them to raise their hands, and counts the number of raised hands. However, even when the method using hand-raising is used, it requires a considerable amount of time to pose a question to the students and to count the number of raised hands. Therefore, this method is not suitable for frequent use. Further, when this method is used, it is easy for a student to select or change whether to raise his/her hand by observing whether other students around the student raise their hands. Therefore, it is highly likely in this method that the student selects whether to raise his/her hand, irrelevantly to whether the student understands. Thus, in this method, a counted number of raised hands may not reflect the degree of understanding of the students.

In order to solve these problems, there is a case in which a terminal being connected to a counting terminal by wire is installed on a desk, and answers are counted by using the counting terminal. However, this method has a problem that the terminal on the desk and a communication wire for connection take up a lot of space.

Therefore, in recent years, a method in which wireless terminals such as a smartphone, a tablet, and a dedicated terminal are used and a degree of understanding of students is confirmed by running application software on the wireless terminals is used in some cases. When these wireless terminals are used, a case in which a school owns the wireless terminals and students use the terminals, and a case in which the student uses a smartphone and the like that the student owns are conceivable.

Herein, PTL 1 discloses a test system that displays a question, detects a direction of a sight line of a user, reads a sight line direction and an answer of the user for the question, and determines whether the sight line direction of the user is directed to a predetermined direction.

### CITATION LIST

### Patent Literature

[PTL 1] Japanese Unexamined Patent Application Publication No. 2017-156410

[PTL 2] Japanese Unexamined Patent Application Publication No. 2017-169684

### SUMMARY OF INVENTION

### Technical Problem

However, the method described in the section of Background Art, in which a wireless terminal is used, has a problem of requiring an expensive communication cost to be paid to a wireless communication provider and the like. In order for the school to own the wireless terminal, the school has to bear the expansive communication cost. Meanwhile, when a smartphone or the like owned by the student is used, understanding from a family of the student, who bears a cost of introducing and a cost of maintaining the smartphone or the like, cannot be acquired in some cases, and it is often difficult for all students to prepare a terminal. In that case, the method in which a wireless terminal is used is difficult to apply.

An object of the present invention is to provide a confirmation device and the like that are able to achieve a balance among an increase in speed of deriving information indicating a selection status of options, space-saving, and a reduction in communication cost.

### Solution to Problem

A confirmation device according to the present invention includes: a display-for-object-person processing means for causing display of options on an image for object person that is an image to be looked at by object persons being persons for whom confirmation by an actor who performs confirmation is conducted; an acquisition processing means for acquiring image information representing an image of the object person gazing at the options; and a first provision processing means for deriving, from a sight line of each of the object persons that is derived from the image information, first selection status information being information indicating a status of selection of the options that the object person selects, and for providing the first selection status information for the actor.

### Advantageous Effects of Invention

The confirmation device and the like according to the present invention enables achieving a balance among an increase in speed of deriving information indicating a selection status of options, space-saving, and a reduction in communication cost.

### BRIEF DESCRIPTION OF DRAWINGS

FIG. 1 is a conceptual diagram illustrating a configuration example of a confirmation system according to the present example embodiment.

FIG. 2 is a conceptual diagram illustrating an outline of an operation to be performed between a teacher, a terminal, and a student.

FIG. 3 is an image diagram illustrating a state (part 1) of a display device for student, a display device for teacher, a teacher, and students.

FIG. 4 is an image diagram illustrating a state (part 2) of the display device for student, the display device for teacher, the teacher, and the students.

FIG. 5 is a conceptual diagram illustrating an example of a processing flow of processing to be performed by a processing unit.

FIG. 6 is a conceptual diagram illustrating processing (part 1) that substitutes processing in S105 to S110.

FIG. 7 is a conceptual diagram illustrating processing (part 2) that substitutes processing in S105 to S110.

FIG. 8 is a block diagram illustrating a minimum configuration of the confirmation device according to the example embodiment.

### EXAMPLE EMBODIMENT

A confirmation system according to the present example embodiment displays a content of a question and options of answers to the question on a screen or the like, and derives a rate of students and the like who select a correct answer, based on sight lines of the students and the like. Thereby, a confirmation device according to the present example embodiment can immediately derive a percentage of correct answers, without using a wired terminal, a smartphone, or the like. Therefore, the confirmation system according to the present example embodiment can achieve a balance among an increase in speed of deriving a percentage of correct answers, space-saving, and a reduction in communication cost.

### <Configuration and Operation>

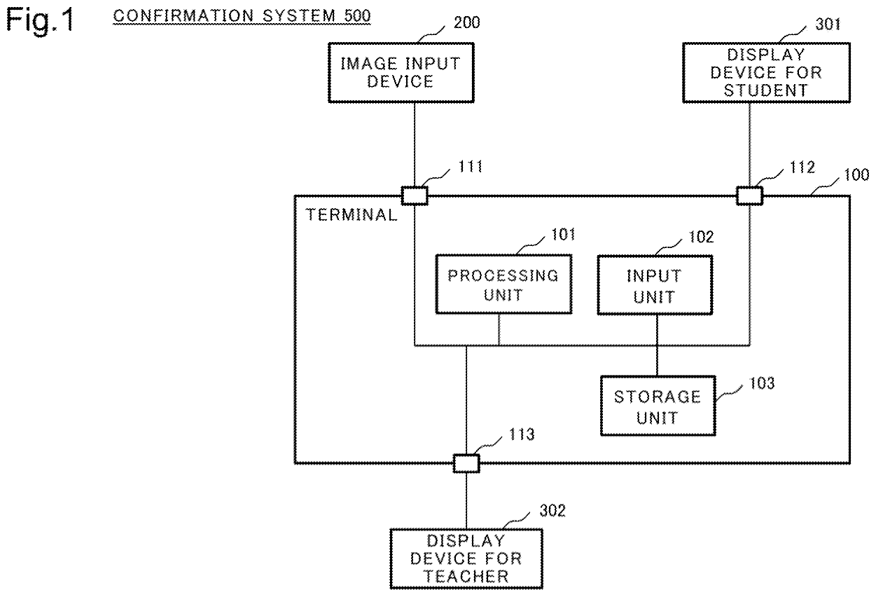

FIG. 1 is a conceptual diagram illustrating a configuration of a confirmation system 500, which is an example of the confirmation system according to the present example embodiment. The confirmation system 500 is a device for a teacher to conduct a test for students.

The confirmation system 500 includes a terminal 100, an image input device 200, a display-device-for-student 301, and a display-device-for-teacher 302. The terminal 100 includes a processing unit 101, an input unit 102, and a storage unit 103. Herein, the terminal 100 is, for example, operated by a teacher. Further, the image input device 200 is a camera and the like that capture an image of all students. Further, the display-device-for-student 301 includes a screen that all the students can look at the same time. Further, the display-device-for-teacher 302 includes a screen that the teacher looks at, and is placed beside the teacher.

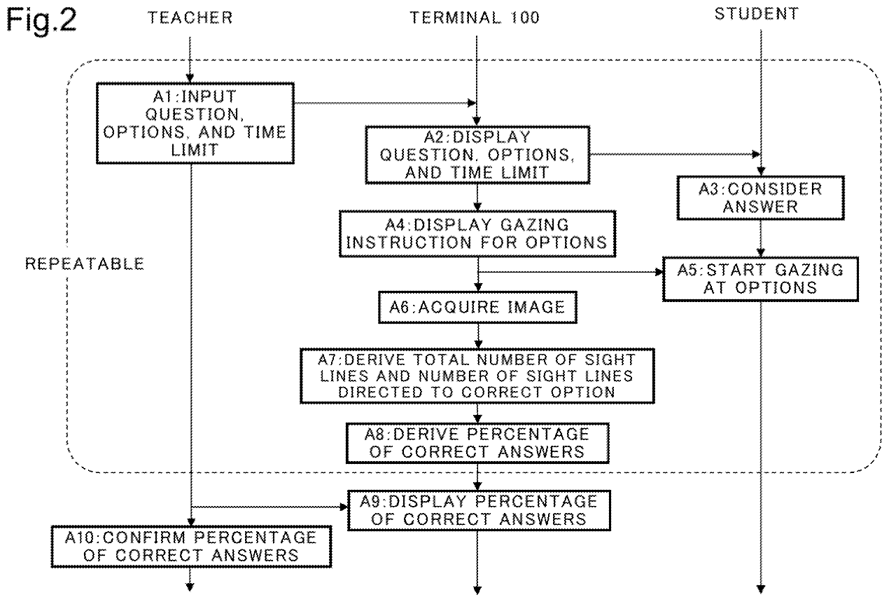

Further, FIG. 2 is a conceptual diagram illustrating an outline of an operation to be performed between the teacher, the terminal 100, and a student. Next, with reference to FIGS. 1 and 2, the outline of the operation to be performed between the teacher, the terminal 100, and the student is described.

When conducting a test for students, as an operation A1 in FIG. 2, the teacher first inputs, to the input unit 102 in FIG. 1, a question, options of answers to the question, and a time limit for answering the question. However, the terminal 100 may derive the options from the question, and in that case, the input of the options to the input unit 102 can be omitted. Further, the time limit may preliminarily be set in the terminal 100, and in that case, the input of the time limit to the input unit 102 can be omitted.

In response to the operation A1, the terminal 100 causes, as an operation A2, the display-device-for-student 301 in FIG. 1 to display the question, the options, and the time limit (a question and the like). The display-device-for-student 301 is a display device that is assumed to be looked at by students. The display-device-for-student 301 is, for example, constituted of a projector and a screen, and the student looks at a screen projected onto the screen by the projector. The processing unit 101 generates a control signal for display, based on information on the question and the like that are input from the input unit 102, transmits the generated control signal to the display-device-for-student 301 via an interface 112, and thereby causes the display-device-for-student 301 to perform the display.

The student looks at the display and, as an operation A3, considers an answer to the displayed question.

When the time limit being input in the operation A1 has elapsed since the display in the operation A2 is started, the terminal 100 performs an operation A4. The operation A4 causes the display-device-for-student 301 to perform an image instructing that the student gaze at an option that the student has selected among the options displayed on the display-device-for-student 301. The display is performed by the processing unit 101 in FIG. 1 generating the control signal for the display and transmitting the generated control signal to the display-device-for-student 301 via the interface 112 at a timing when the time limit being input from the input unit 102 has been elapsed since the display in A2.

In response to the display in A4, the student starts, as an operation A5, gazing at the option that the student selects.

After that, the terminal 100 causes the image input device 200 in FIG. 1 to capture an image of all the students. The image may be a still image or a moving image. The image input device 200 is installed, for example, in a position and an orientation where a front view of faces of all the students can be captured when all the students gaze at the options. The position is, for example, near the center just above the screen at which the students look. Further, the orientation is, for example, toward a center of all the students. Further, a resolution of the captured image is assumed to be, for example, a degree at which eyes of each of the students are captured with a certain degree of clarity. A reason for this is that, as described below, the terminal 100 identifies an option selected by each of the students, based on a direction of a sight line of each of the students, and in order to identify the direction of the sight line, it is generally required that an image of eyes is acquired with a certain degree of clarity.

Image information of the image captured by the image input device 200 is input to the terminal 100 via an interface 111 in FIG. 1, and stored in the storage unit 103 by the processing unit 101.

Next, the terminal 100 derives, as an operation A7, a total number of sight lines of the students and the number of sight lines directed to a correct option, from the image acquired in the operation A6. Herein, the total number of sight lines is, for example, half of the number of eyes of the students present in the image.

Further, in order to derive the number of sight lines gazing at the correct option, for example, first, a direction of a sight line of each of the students is derived from an image of eyes of each of the students. A method of deriving a direction of a sight line from shapes of eyes is well known, and is disclosed, for example, in PTL 2.

Further, the terminal 100 is assumed to preliminarily hold information indicating a position of eyes (or a face) of each of the students at a time of gazing, in the storage unit 103 in FIG. 1. Further, the terminal 100 is assumed to preliminarily hold, in the storage unit 103, information representing an association between the captured image and a position of eyes of each of the students at the time of gazing in a space within a classroom. Further, the terminal 100 is assumed to hold a position of the correct option on a screen, which is displayed on the display-device-for-student 301, in the space within the classroom.

In that case, the terminal 100 derives the number of sight lines of which a position on a displayed screen, which is derived from a sight line of each of the students in the image and a position of eyes of each of the students, is in a position of the correct option on the displayed screen, and can thereby derive the number of sight lines gazing at the correct option.

Then, as an operation A8, the terminal 100 derives a percentage of correct answers, by dividing the number of sight lines directed to the correct option derived in the operation A7 by the total number of sight lines of the students.

Then, as an operation A9, the terminal 100 causes the display-device-for-teacher 302 in FIG. 1 to display the derived percentage of correct answers. The display is caused to perform by the processing unit 101 in FIG. 1 generating a control signal for display and transmitting the generated control signal to the display-device-for-teacher 302 via an interface 113. Note that, the display-device-for-teacher 302 is a display device that is assumed to be looked at by a teacher, and is a display, for example. The display-device-for-teacher 302 is placed, for example, on a teaching platform or near the teaching platform.

Then, as an operation A10, the teacher confirms the percentage of correct answers that is displayed on the screen of the display-device-for-teacher 302. The teacher and the like recognize a degree of understanding of the students from the displayed percentage of correct answers, and can reflect the degree of understanding in a subsequent class.

Note that the operations A1 to A8 in FIG. 2 may be repeated by the teacher operating the input unit 102. In that case, as the operation A9, the terminal 100 causes the display-device-for-teacher 302 to display, for example, a percentage of correct answers for each question which is input in operation A1, in association with the question.

Herein, a supplementary description of the configuration in FIG. 1 is provided. The input unit 102 is, for example, a keyboard or a touch panel, which is assumed to be operated by a teacher. The input unit 102 causes the storage unit 103 to store input information in accordance with an instruction from the processing unit 101.

The storage unit 103 preliminarily holds a program and information necessary for the processing unit 101 to operate. Further, the storage unit 103 stores information that is instructed by the processing unit 101. Further, the storage unit 103 transmits the information instructed by the processing unit 101 to an instructed configuration.

The terminal 100 is, for example, a computer. Further, the processing unit 101 is, for example, a central processing unit of the computer.

The image input device 200 performs image capturing in accordance with instruction information that is transmitted from the terminal 100 via the interface 111, and transmits image information acquired from the image capturing to the terminal 100. Each of the display-device-for-student 301 and the display-device-for-teacher displays an image in accordance with control information transmitted from the terminal 100.

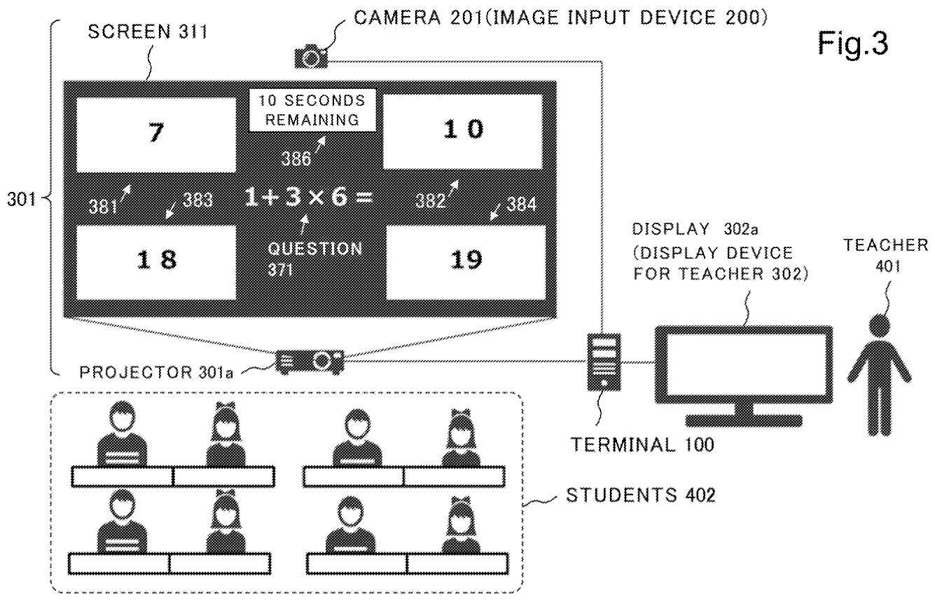

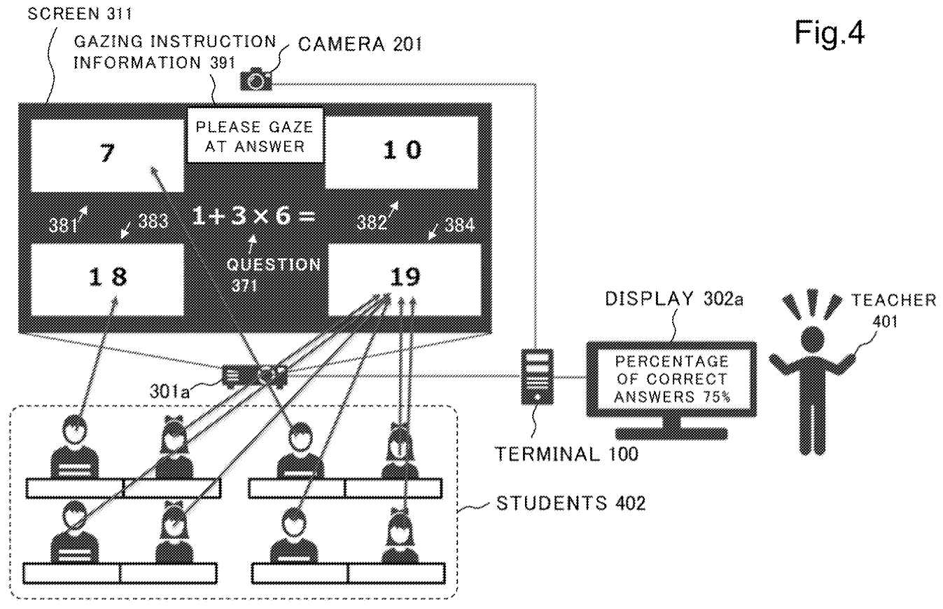

Next, specific examples of the operations in FIG. 2 are described by using FIGS. 3 and 4. In those specific examples, the number of students is assumed to be eight.

FIG. 3 is a diagram that illustrates by an image illustrating a state of the display-device-for-student 301, the display-device-for-teacher 302, a teacher 401, and students 402 in a state of the operation A3 after the operations A1 and A2 in FIG. 2. Note that, since FIGS. 3 and 4 are image diagrams, FIGS. 3 and 4 do not reflect an actual arrangement of the display-device-for-student 301, the display-device-for-teacher 302, the teacher 401, and the students 402.

Further, in FIGS. 3 and 4, the display-device-for-student 301 in FIG. 1 is constituted of a projector 301a and a screen 311 onto which an image is projected by the projector 301a. The screen 311 is installed in front of the students 402. The screen 311 may be a mere wall or the like, as long as an image can be projected by the projector 301a onto the screen 311.

Further, the image input device 200 in FIG. 1 is a camera 201. The camera 201 is installed directly above a center of the screen 311 in an orientation that an entire image of the students 402 can be substantially symmetrically captured.

Further, the display-device-for-teacher 302 in FIG. 1 is a display 302a. The display 302a is installed in a position where the teacher 401 can easily look at.

The screen 311 in FIG. 3 displays a question 371, which is a specific example of the above-described question, options 381 to 384, which are specific examples of the above-described options, and a remaining time 386, which are displayed in the operation A2. In this example, the options 381 to 384 are displayed apart from each other near four corners of the screen 311. By displaying the options apart from each other in such a way, it becomes easier to derive the number of sight lines that are directed to the correct option in the operation A7 in FIG. 2.

Note that, the remaining time 386 is a remaining time until the time limit that is displayed in the operation A2 has elapsed.

FIG. 4 is a diagram illustrating, by an image, a state of the display-device-for-student 301, the display-device-for-teacher 302, the teacher 401, and the students 402 immediately after the operation A9 in FIG. 2 is performed.

The operations A6 to A9 in FIG. 2 in the terminal 100 are performed by the terminal 100 in FIG. 4, which is a computer, and are therefore performed in a short time. Therefore, immediately after the operation A9 is performed, gazing instruction information 391, which is an example of the gazing instruction for an option, which is performed in the operation A4, is displayed on the screen 311.

Further, each of the students 402 gazes at any one of the options 381 to 384, which is selected by the student. Each arrow illustrated in FIG. 4 represents a sight line of each of the students. In this example, sight lines of six students among eight students are directed to the option 384, which is correct.

The terminal 100 causes, in the operation A9, the display 302a to display the percentage of correct answers derived in the operations A7 and A8 in FIG. 2 from an image of the students 402 while gazing captured from a front. In this example, six of a total number of sight lines, which is eight, are directed to the option 384, which is correct, and therefore 75% is displayed on the display 302a as a percentage of correct answers. The teacher 401 looks at the percentage of correct answers, which is 75%, displayed on the display 302a and thereby recognize a degree of understanding of the students 402 for the question 371. Then, the teacher 401 can adjust a content of a subsequent class and the like, based on the degree of understanding.

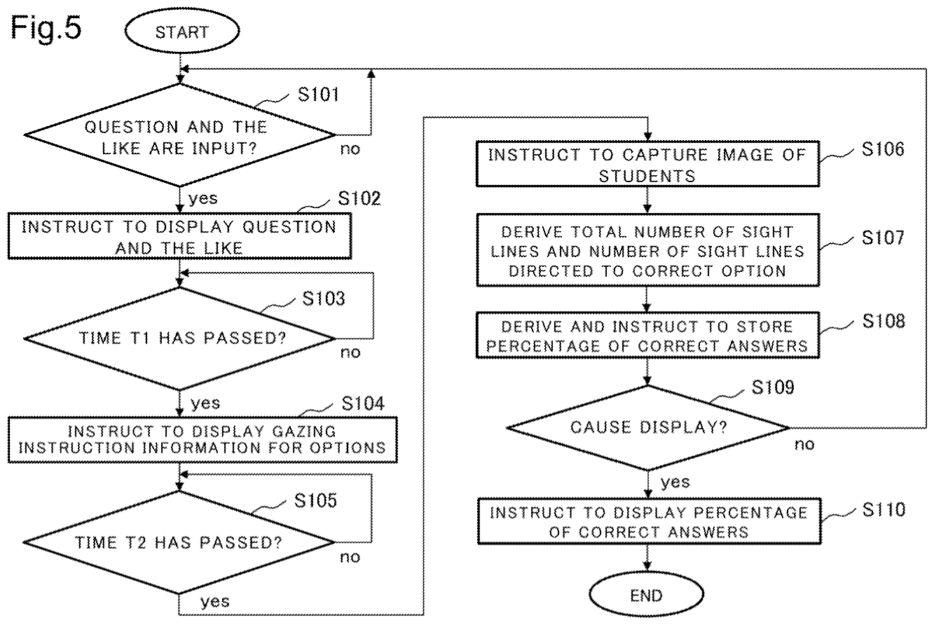

FIG. 5 is a conceptual diagram illustrating an example of a processing flow of processing to be performed by the processing unit 101 in FIG. 1 in order to perform the operations in FIG. 2.

The processing unit 101 starts processing in FIG. 5, for example, in response to an input of start information to the input unit 102 in FIG. 1.

The processing unit 101 first determines, as processing in S101, whether a question and the like are input from the input unit 102. Herein, the question and the like are at least information including the question. The processing unit 101 performs processing in S102 when a determination result of the processing in S101 is yes. Meanwhile, the processing unit 101 performs the processing in S101 again when the determination result of the processing in S101 is no.

When performing the processing in S102, the processing unit 101 causes, as the processing in S102, the display-device-for-student 301 to display the question and the like being input in the processing in S101. Then, the processing unit 101 determines, as processing in S103, whether a time T1 has elapsed. The time T1 is a waiting time from when the processing in S102 is performed to when processing in S104 is performed, and is preliminarily set.

The processing unit 101 performs the processing in S104 when a determination result of the processing in S103 is yes. Meanwhile, the processing unit 101 performs the processing in S103 again when the determination result of the processing in S103 is no. When performing the processing in S104, the processing unit 101 causes, as the processing in S104, the display-device-for-student 301 to display the above-described gazing instruction information for an option.

Then, the processing unit 101 determines, as processing in S105, whether a time T2 has elapsed. The time T2 is a waiting time from when the processing in S104 is performed to when processing in S106 is performed, and is preliminarily set.

The processing unit 101 performs the processing in S106 when a determination result of the processing in S105 is yes. Meanwhile, the processing unit 101 performs the processing in S105 again when the determination result of the processing in S105 is no. When performing the processing in S106, the processing unit 101 causes, as the processing in S106, the image input device 200 to capture an image of students and to transmit acquired image information.

Then, the processing unit 101 derives a total number of sight lines of the students and the number of sight lines that are directed to a correct option, based on the image information transmitted from the image input device 200. Then, as processing in S108, the processing unit 101 derives a percentage of correct answers and causes the storage unit 103 to store the derived percentage of correct answers.

Then, the processing unit 101 determines, as processing in S109, whether to cause the display-device-for-teacher 302 to display at this point all the percentages of correct answers that are stored in the storage unit 103 from a start to date. The processing unit 101 performs the determination, based on input information to the input unit 102, for example. The processing unit 101 performs processing in S110 when a determination result of the processing in S109 is yes. Meanwhile, the processing unit 101 performs the processing in S101 again when the determination result of the processing in S109 is no (for example, when it is desired not to display the percentage of correct answers yet at this point and to collectively display the percentages of correct answers later).

When performing the processing in S110, the processing unit 101 causes, as the processing in S110, the display-device-for-teacher 302 to display the percentage of correct answers, which is stored in the storage unit 103. Then, the processing unit 101 ends the processing in FIG. 5.

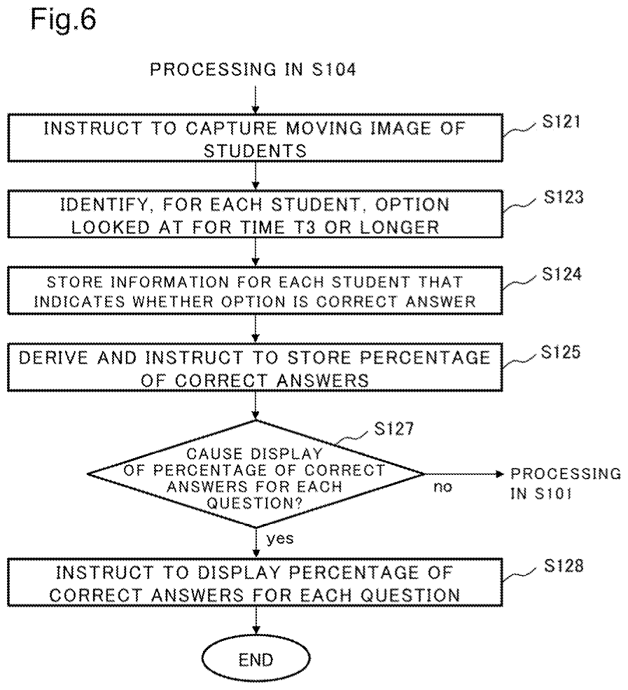

It is presumed in the processing in FIG. 5 that all the students gaze at the same time. However, when the number of students is large and the like, such simultaneous gazing may be difficult to achieve. In such a case, it is effective, for example, to capture a moving image of the students and derive a percentage of correct answers by regarding an option that each of the students gazes at for a certain period of time or longer as an option that the student selects. Such processing is achieved by substituting the processing in S105 to S110 in FIG. 5 for processing in FIG. 6.

FIG. 6 is a conceptual diagram illustrating processing (part 1) that substitutes the processing in S105 to S110 in FIG. 5.

Next to the processing in S104 in FIG. 5, the processing unit 101 causes, as processing in S121, the image input device 200 to capture a moving image of the students. Herein, it is presumed that the image input device 200 is a camera or the like that is capable of capturing a moving image. The image input device 200 captures a moving image of the students for a predetermined period of time and transmits moving image information representing the moving image to the terminal 100. The processing unit 101 causes the storage unit 103 to store the moving image information.

Then, the processing unit 101 identifies, as processing in S123, by using the moving image information, an option that a student at each position in the moving image gazes at for a time T3 or longer. Then, as processing in S124, the processing unit 101 determines, for the student at each position, whether the option identified in the processing in S123 is a correct answer, and causes the storage unit 103 to store information indicating whether the option is the correct answer.

Next, as processing in S125, the processing unit 101 derives a percentage of correct answers for the question being input in the processing in S101, associates the derived percentage of correct answers with identification information of the question, and causes the storage unit 103 to store the percentage of correct answers.

Then, the processing unit 101 determines, as processing in S127, whether to display percentages of correct answers for each of all questions that have been stored in the storage unit 103 from a start until now. The processing unit 101 performs the determination by, for example, determining whether a predetermined input information is input via the input unit 102.

The processing unit 101 performs processing in S128 when a determination result of the processing in S127 is yes. Meanwhile, the processing unit 101 performs the processing in S101 in FIG. 5 again when the determination result of the processing in S127 is no (for example, when it is desired not to display the percentage of correct answers yet at this point and to collectively display the percentages of correct answers later).

When performing the processing in S128, the processing unit 101 causes, as the processing in S128, the display-device-for-teacher 302 to display all combinations of identification information of a question and a percentage of correct answers, which are stored in the storage unit 103 after the processing in FIG. 5 is started. Then, the processing unit 101 ends the processing in FIG. 6.

In the above-described example, a case in which the processing unit 101 does not perform personal identification of each of the students has been described. However, the processing unit 101 may identify each of the students and may derive, for each of the students, a percentage of correct answers.

Such identification of each of the students is possible when, for example, the processing unit 101 is in an environment in which a seating chart preliminarily stored in the storage unit 103 can be used, the students are seated according to the seating chart, and further, there is association information between faces (eyes) in an image to be acquired and the seating chart.

Alternatively, even when seating positions of the students are not fixed, such identification of each of the students can be achieved by identifying each of the students by using a well-known face authentication technology.

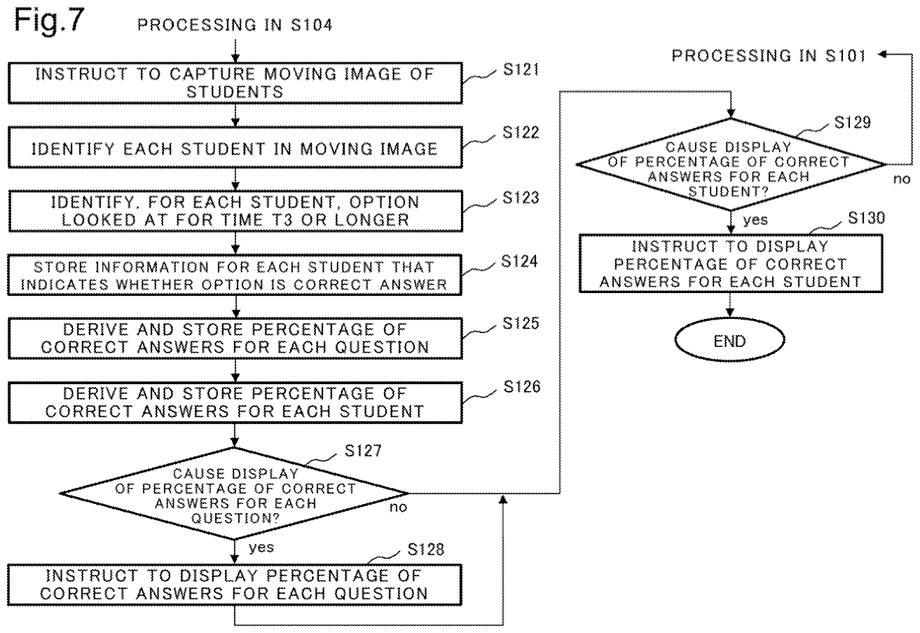

An example of a processing flow of identifying each of the students is, for example, acquired by replacing the processing in S105 to S110 in FIG. 5 with processing in FIG. 7. FIG. 7 is a conceptual diagram illustrating processing (part 2) that substitutes the processing in S105 to S110 in FIG. 5.

Processing in S121 in FIG. 7 is the same as the processing in S121 in FIG. 6, and therefore description thereof is omitted. Next to the processing in S121, the processing unit 101 identifies, as processing in S122, each of the students included in the moving image. The processing unit 101 performs the identification, based on, for example, the above-described seating chart. Alternatively, the processing unit 101 performs the identification by face-authenticating a face of each of the students in the image. The identification using face authentication has an advantage over the identification using the seating chart in that the identification can be performed regardless of which seat the student is seated in.

Processing in S123 to S125 to be subsequently performed is the same as the processing in S123 to S125 in FIG. 6, and therefore description thereof is omitted.

Next to the processing in S125, the processing unit 101 aggregates information indicating whether each question is correctly answered by each of the students, which is previously stored in the storage unit 103, derives, for each of the students, a percentage of correct answers, and causes the storage unit 103 to store the percentage of correctly answered questions.

Processing in S127 and S128, which is performed thereafter, is the same as the processing in S127 and S128 in FIG. 6, and therefore description thereof is omitted.

Next to the processing in S127 and S128 in FIG. 7, the processing unit 101 determines, as processing in S129, whether to cause the display-device-for-teacher 302 to display the percentage of correctly answered questions for each of the students. When a determination result of the processing in S129 is yes, the processing unit 101 causes, as processing in S130, the display-device-for-teacher 302 to display the percentage of correctly answered questions for each identified student, which is stored in the storage unit 103 in the processing in S126 that is performed at the last time. Thereby, the teacher can recognize a degree of understanding for a class content and the like for each personal-identified student.

### Advantageous Effect

In the confirmation system according to the present example embodiment, a question content and options of the answers are displayed on the display-device-for-student, and a rate of sight lines directed to a correct option is displayed to the teacher, as a percentage of correct answers. Thereby, the confirmation system according to the present example embodiment makes it possible to immediately provide the percentage of correct answers to the teacher without using a wired terminal or a wireless terminal such as a smartphone. Therefore, the confirmation device according to the present example embodiment can achieve a balance among an increase in speed of deriving a percentage of correct answers, space-saving, and a reduction in communication cost.

Note that, in the above-described example, for ease of understanding, description has been made on a case in which the confirmation system is a system for a teacher to conduct a test for students. However, the confirmation device according to the example embodiment may be any other device as long as the device has an object person select an option displayed on a screen, and acquires selection status information indicating a status of the selection using a sight line of the object person. Such acquisition of selection status information includes, for example, acquisition of selection status information that is performed in order to confirm a degree of understanding or for a questionnaire, which is conducted during a performance. When acquisition of selection status information is performed for a questionnaire, and the like, there may be no correct answer, or there may be no question to begin with. When a question does not exist, the confirmation device according to the example embodiment causes a screen for object person to display options, but does not cause the screen for object person to display a question. Herein, the object person is an object person of the questionnaire or a listener of a lecture. Further, even in a case in which a question exists, such as a survey, the question may not be displayed on the screen for object person and may be provided to the object person by voice and the like. Further, the question may be presented to the object person by a person such as a lecturer. Also in those cases, the confirmation device according to the present example embodiment does not display the question on the screen for object person. Further, the confirmation device according to the present example embodiment may display a question on the screen for object person before or after options are displayed.

Further, provision of the above-described percentage of correct answers to an actor who conducts confirmation such as testing may be performed by the confirmation device according to the example embodiment by using information other than an image, such as voice.

Further, information to be provided to the actor does not have to be the percentage of correct answers and may be the selection status information, which is information indicating a status of option selection.

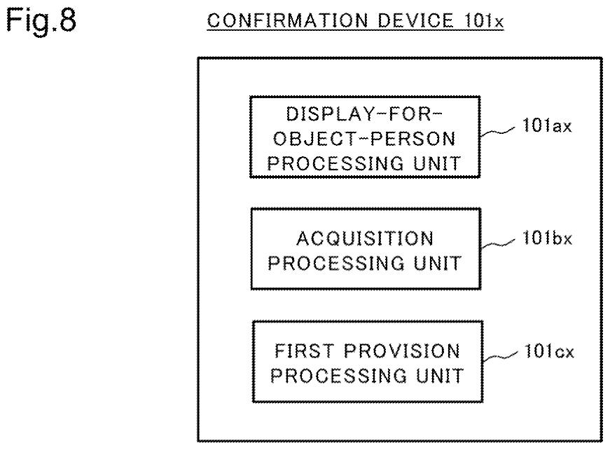

FIG. 8 is a block diagram illustrating a configuration of a confirmation device 101x, which is a minimum configuration of the confirmation device according to the example embodiment. The confirmation device 101x includes a display-for-object-person processing unit 101ax, an acquisition processing unit 101bx, and a first provision processing unit 101cx.

The display-for-object-person processing unit 101ax causes display of options on an image for object person, which is an image to be looked at by object persons being persons for whom confirmation by an actor who implements the confirmation is conducted. The acquisition processing unit 101bx acquires image information representing an image of the object person gazing at the options. The first provision processing unit 101cx derives, from a sight line of each of the object persons which is derived from the image information, first selection status information, which is information indicating a status of the selection of the options that the object person selects, and provides the first selection status information to the actor.

The confirmation device 101x causes display of options on the image for object person. Further, the confirmation device 101x derives, from a sight line of each of the object persons which is derived from an acquired image of the object persons gazing at the question and the option, first selection status information being information indicating a status of the selection of the options that the object person selects, and provides the derived first selection status information to the actor. Thereby, the confirmation device 101x makes it possible to immediately provide the first selection status information to a teacher without using a wired terminal or a wireless terminal such as a smartphone. Therefore, the confirmation device 101x can achieve a balance among an increase in speed of deriving information indicating a status of the selection of the options, space-saving, and a reduction in communication cost.

Therefore, by the above-described configuration, the confirmation device 101x achieves the advantageous effect described in the section of

### Advantageous Effects of Invention

Further, the entirety or a part of the example embodiment may also be described as the supplementary notes below, but is not limited thereto.

### (Supplementary Note 1)

A confirmation device comprising:

a display-for-object-person processing means for causing display of options on an image for object person that is an image to be looked at by object persons being persons for whom confirmation by an actor who performs confirmation is conducted;

an acquisition processing means for acquiring image information representing an image of the object person gazing at the options; and

a first provision processing means for deriving, from a sight line of each of the object persons that is derived from the image information, first selection status information being information indicating a status of selection of the options that the object person selects, and for providing the first selection status information for the actor.

### (Supplementary Note 2)

The confirmation device according to supplementary note 1, wherein the display-for-object-person processing means causes the display-for-object-person processing means to display a question for the options at a time of displaying the options or before the options are displayed.

### (Supplementary Note 3)

The confirmation device according to supplementary note 2, wherein the first selection status information is first degree-status-information indicating a degree to which the option is a correct answer to the question.

### (Supplementary Note 4)

The confirmation device according to supplementary note 1, wherein the first selection status information is a percentage of correct answers indicating a probability that an answer is a correct answer of a question.

### (Supplementary Note 5)

The confirmation device according to supplementary note 4, wherein the display-for-object-person processing means causes display of the question on the image for object person.

### (Supplementary Note 6)

The confirmation device according to any one of supplementary notes 1 to 5, wherein

the display-for-object-person processing means causes display of information prompting the gazing on the image for object person, after the options are displayed, and

after the information prompting the gazing is displayed, the acquisition processing means performs the acquisition.

### (Supplementary Note 7)

The confirmation device according to any one of supplementary notes 1 to 6, wherein the image information is still image information.

### (Supplementary Note 8)

The confirmation device according to any one of supplementary notes 1 to 7, wherein the image information is moving image information.

### (Supplementary Note 9)

The confirmation device according to supplementary note 8, wherein the first provision processing means derives the first selection status information, by using the moving image information, from the options at which the object persons perform the gazing for a first time or longer.

### (Supplementary Note 10)

The confirmation device according to any one of supplementary notes 1 to 9, wherein the first provision processing means causes display of the first selection status information on an image for actor that is an image to be looked at by the actor.

### (Supplementary Note 11)

The confirmation device according to any one of supplementary notes 1 to 10, further comprising a second provision processing means for providing, for the actor, second selection status information being information indicating a status of the selection of a plurality of the question options for each of the object persons.

### (Supplementary Note 12)

The confirmation device according to any one of supplementary notes 1 to 11, further comprising an identification processing means for identifying each of the object persons.

### (Supplementary Note 13)

The confirmation device according to supplementary note 12, wherein the identification is performed by using face authentication on a face image of each of the object persons being included in the image.

### (Supplementary Note 14)

The confirmation device according to any one of supplementary notes 1 to 13, wherein the actor is a teacher, and the object person is a student.

### (Supplementary Note 15)

The confirmation device according to any one of supplementary notes 1 to 14, wherein the actor is a performer, and the object person is a listener.

### (Supplementary Note 16)

A confirmation system comprising:

the confirmation device according to any one of supplementary notes 1 to 15; and

at least any one of:

a display device for object person that displays the image for object person; a display device for actor that displays the first selection status information on an image for actor that is an image to be looked at by the actor; and an image input device that inputs the image information to the confirmation device.

### (Supplementary Note 17)

A confirmation method comprising:

causing display of options on an image for object person that is an image to be looked at by object persons being persons for whom confirmation by an actor who performs confirmation is conducted;

acquiring image information representing an image of the object person gazing at the options;

deriving, from a sight line of each of the object persons that is derived from the image information, first selection status information being information indicating a status of selection of the options that the object person selects; and

providing the first selection status information for the actor.

### (Supplementary Note 18)

A recording medium recording a confirmation program causing a computer to execute:

processing of causing display of options on an image for object person that is an image to be looked at by object persons being persons for whom confirmation by an actor who performs confirmation is conducted; processing of acquiring image information representing an image of the object person gazing at the options; and

processing of deriving, from a sight line of each of the object persons that is derived from the image information, first selection status information being information indicating a status of selection of the options that the object person selects, and of providing the first selection status information for the actor.

Note that, the actor in the above-described supplementary notes is, for example, the teacher in FIG. 2 or the teacher 401 in FIG. 3 or 4. Further, the object person is, for example, the student in FIG. 2 or the student 402 in FIG. 3 or 4. Further, the image for object person is an image projected onto, for example, the screen 311 in FIG. 3 or 4.

Further, the question is, for example, the question 371 in FIG. 3 or 4. Further, the options are, for example, the options 381 to 384 in FIG. 3 or 4. Further, the display-for-object-person processing unit is, for example, a part of the processing unit 101 in FIG. 1 that performs the operation A2 in FIG. 2 or the processing in S102 in FIG. 5.

Further, the acquisition processing unit is, for example, a part of the processing unit 101 in FIG. 1 that performs the operation A6 in FIG. 2, the processing in S106 in FIG. 5, or the processing in S121 in FIG. 6 or 7. Further, the first selection status information is, for example, a percentage of correct answers that is displayed on the display 302a in FIG. 4. Further, the first provision processing unit is, for example, a part of the processing unit 101 in FIG. 1 that performs the operation A9 in FIG. 2, the processing in S110 in FIG. 5, or the processing in S128 in FIG. 6 or 7.

Further, the confirmation device is, for example, the terminal 100 in FIG. 1 or 2, or the processing unit 101 in FIG. 1. Further, the percentage of correct answers is, for example, the percentage of correct answers that is displayed on the display 302a in FIG. 4. Further, the information prompting gazing is, for example, the gazing instruction information 391 in FIG. 4. Further, the confirmation device according to supplementary note 5 is, for example, the terminal 100 in FIG. 1 or 2, or the processing unit 101 in FIG. 1, which performs the processing in FIG. 6 or 7.

Further, the image for actor is, for example, an image that is displayed on the display 302a in FIG. 3 or 4. Further, the second degree-information is, for example, the percentage of correctly answered questions for each student in S129 or S130 in FIG. 7. Further, the second provision processing unit is, for example, the processing unit 101 in FIG. 1 that performs the processing in S130 in FIG. 7. Further, the first degree-status-information is, for example, the percentage of correct answers, which is displayed on the display 302a in FIG. 4.

Further, the identification processing unit is, for example, the processing unit 101 in FIG. 1 that performs the processing in S122 in FIG. 7. Further, the computer is, for example, a computer (a combination of the processing unit 101 and the storage unit 103) that is included in the terminal 100 in FIG. 1. Further, the confirmation program is, for example, a program that causes the computer (the combination of the processing unit 101 and the storage unit 103) included in the terminal 100 in FIG. 1 to execute processing.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

### REFERENCE SIGNS LIST

100 Terminal
101 Processing unit
101ax Display-for-object-person processing unit
101bx Acquisition processing unit
101cx First provision processing unit
101x Confirmation device
102 Input unit
103 Storage unit
111, 112, 113 Interface
200 Image input device
201 Camera
301 Display device for student
301a Projector
302 Display device for teacher
302a Display
311 Screen
371 Question
381, 382, 383, 384 Option
386 Remaining time
391 Gazing instruction information
401 Teacher
402 Student
500 Confirmation system

What is claimed is:

1. A confirmation device comprising one or more memories storing instructions and one or more processors configured to execute the instructions to:
cause display of options on an image for object person that is an image to be looked at by object persons being persons for whom confirmation by an actor who performs confirmation is conducted;
acquire image information representing an image of the object person gazing at the options;
derive, from a sight line of each of the object persons that is derived from the image information, first selection status information being information indicating a status of selection of the options that the object person selects; and
provide the first selection status information for the actor.

2. The confirmation device according to claim 1, wherein the one or more processors are configured to execute the instructions to cause display of a question for the options on the image for object person at a time of displaying the options or before the options are displayed.

3. The confirmation device according to claim 2, wherein the first selection status information is first degree-status-information indicating a degree to which the option is a correct answer to the question.

4. The confirmation device according to claim 1, wherein the first selection status information is a percentage of correct answers indicating a rate that an answer is a correct answer of a question.

5. The confirmation device according to claim 4, wherein the one or more processors are configured to execute the instructions to cause display of the question on the image for object person.

6. The confirmation device according to claim 1, wherein the one or more processors are configured to execute the instructions to
cause display of information prompting the gazing on the image for object person, after the options are displayed, and,
after the information prompting the gazing is displayed, perform the acquisition.

7. The confirmation device according to claim 1, wherein the image information is still image information.

8. The confirmation device according to claim 1, wherein the image information is moving image information.

9. The confirmation device according to claim 8, wherein the one or more processors are configured to execute the instructions to derive the first selection status information, by using the moving image information, from the options at which the object persons perform the gazing for a first time or longer.

10. The confirmation device according to claim 1, wherein the one or more processors are configured to execute the instructions to cause display of the first selection status information on an image for actor that is an image to be looked at by the actor.

11. The confirmation device according to claim 1, wherein the one or more processors are configured to execute the instructions to provide, for the actor, second selection status information being information indicating a status of the selection of a plurality of the options for each of the object persons.

12. The confirmation device according to claim 1, wherein the one or more processors are configured to execute the instructions to identify each of the object persons.

13. The confirmation device according to claim 12, wherein the identification is performed by using face authentication on a face image of each of the object persons being included in the image.

14. The confirmation device according to claim 1, wherein the actor is a teacher, and the object person is a student.

15. The confirmation device according to claim 1, wherein the actor is a lecturer, and the object person is a listener.

16. A confirmation system comprising:
the confirmation device according to claim 1, and
at least any one of: a display device for object person that displays the image for object person; a display device for actor that displays the first selection status information on an image for actor that is an image to be looked at by the actor; and an image input device that inputs the image information to the confirmation device.

17. A confirmation method comprising:
causing display of options on an image for object person that is an image to be looked at by object persons being persons for whom confirmation by an actor who performs confirmation is conducted;
acquiring image information representing an image of the object person gazing at the options;
deriving, from a sight line of each of the object persons that is derived from the image information, first selection status information being information indicating a status of selection of the options that the object person selects; and
providing the first selection status information for the actor.

18. A non-transitory computer-readable recording medium recording a confirmation program causing a computer to execute:
processing of causing display of options on an image for object person that is an image to be looked at by object persons being persons for whom confirmation by an actor who performs confirmation is conducted;
processing of acquiring image information representing an image of the object person gazing at the options; and
processing of deriving, from a sight line of each of the object persons that is derived from the image information, first selection status information being information indicating a status of selection of the options that the object person selects, and of providing the first selection status information for the actor.
